(19) United States
(12) Patent Application Publication
(10) Pub. No.: US 2008/0264739 A1
(43) Pub. Date: Oct. 30, 2008

(54) Disc Brake, in Particular for a Commercial Vehicle and Retaining Bracket for Fixing the Brake Linings of a Disc Brake

(75) Inventors: Wolfgang PRITZ, Aldersbach (DE); Jose CAMILO-MARTINEZ, Unterhaching (DE)

Correspondence Address: CROWELL & MORING LLP;INTELLECTUAL PROPERTY GROUP, P.O. BOX 14300, WASHINGTON, DC, 20044-4300, US

(73) Assignee: KNORR-BREMSE SYSTEME FUER NUTZFAHRZEUGE GMBH, Muenchen (DE)

(21) Appl. No.: 12/113,799

(22) Filed: May 1, 2008

Related U.S. Application Data
(63) Continuation of application No. PCT/EP2006/010512, filed on Nov. 2, 2006.

(30) Foreign Application Priority Data
Nov. 3, 2005 (DE) 10 2005 052 437.0

(51) Int. Cl. F16D 55/00

(52) U.S. Cl. 188/73.31

(57) ABSTRACT

A disc brake for a commercial vehicle includes a brake caliper, which has a receiving chamber for an application device and encloses a brake disc, against which brake linings can be pressed during a braking procedure, and a retaining bracket. The retaining bracket is detachably fixed to the brake caliper, and lining retainer springs that act on outer edges of the brake linings are supported on the retaining bracket. Preferably, one end of the retaining bracket is connected to the brake caliper, and the other end is held by a securing element. The disc brake is configured in such a way that the securing element is inserted into at least one cavity of the brake caliper in the longitudinal direction of the retaining bracket and lies against at least one buffering edge of the retaining bracket, secured against displacement in the insertion direction.

This application is a continuation of international application PCT/EP2006/010512, filed Nov. 2, 2006, the entire disclosure of which is incorporated herein by reference, and claims priority to German patent application 10 2005 052 437.0, filed Nov. 3, 2005.

Cross-reference is hereby made to the U.S. national phase applications of international applications PCT/EP2006/010517 (published as WO 2007/051618 A1 on May 10, 2007) and PCT/EP2006/010516 (published as WO 2007/051617 A1 on May 10, 2007).

### BACKGROUND AND SUMMARY OF THE INVENTION

This invention relates to a disk brake for a commercial vehicle including a brake caliper that has a receiving space for a brake application device and encloses a brake disk, against which brake linings can be pressed during a brake operation, and a retaining bracket, fastened releasably to the brake caliper, on which lining holding springs that act on the outer edges of the brake linings are supported. The retaining bracket is connected with one end positively to the brake caliper, and held with its other end by way of a securing element. The invention also relates to the retaining bracket itself for fixing brake linings of such a disk brake.

A retaining bracket of a disk brake of this type, as is known, for example, from German document DE 86 150 15 U1, serves mainly as an abutment for springs; in the case of this known disk brake, the abutment is for leaf springs which clamp the brake linings resiliently.

The retaining bracket is fastened releasably to the brake caliper, with the result that both rapid mounting and dismantling of the brake linings is possible. This is done in order to make access to the brake linings, which is necessary to change the brake linings, possible without problems.

This is also aided by permitting the retaining bracket to be simply mounted and dismantled, for which purpose the bracket is first plugged into a pocket-shaped receptacle of the brake caliper and, second, connected fixedly to the brake caliper by screwing, such that it bridges a plug-in opening for the brake linings.

Here, the pocket-shaped receptacle is provided on that side of the brake caliper that forms the brake outer side and lies opposite the brake application device, which is arranged in the brake caliper and forms the brake inner side, that is to say the side which faces the center of the vehicle. The receptacle can be made by mechanical machining or, if the brake caliper is produced by casting, can be formed integrally at the same time.

As mentioned above, the retaining bracket is screwed to the brake caliper by way of its other end, which faces the brake application device. However, corresponding complicated machining is required for this purpose, that is to say drilling of the core hole and subsequent cutting of the thread. Since disk brakes of this type are produced in great numbers, these work operations stand in the way of optimized production, with the result that the product, overall, can be produced only with correspondingly high expenditure.

This is also true of a disk brake in which the pocket-shaped receptacle is provided on that side of the brake caliper which forms the brake inner side. The retaining bracket is fixed on the opposite side, that is to say the brake outer side, by way of a pin, a washer, and a cotter pin, with the pin being connected positively to the brake caliper. This positive connection is produced above the retaining bracket, which, together with the washer, is pressed down by the cotter pin and fixed to the pin.

The connection pin, washer, and cotter pin require a corresponding amount of installation space, which can be produced only with considerable expenditure on account of the narrow space conditions which prevail.

Moreover, machining of the hole on the brake caliper side for receiving the pin is required in a manner deviating from the main machining direction, as a result of which the production, overall, is made more difficult. Production of the core hole and cutting of the thread for producing the screw connection can also take place only in a manner which deviates from the main machining direction, and the same disadvantages result.

Additionally, in known disk brakes, there is a risk that, in principle, the securing element will be released and lost, particularly during driving operation. As a result, the retaining bracket may no longer fulfill its function, and failure of the disk brake may result as a consequence.

One object of the invention, therefore, is the object of developing a disk brake and a retaining bracket in such a way that they can be produced less expensively and permit simpler and quicker mounting and dismantling of the brake linings, and so that operational reliability is improved overall.

This object is achieved in one way by a disk brake having the securing element plugged into at least one receptacle of the brake caliper in a longitudinal axial direction of the retaining bracket and bearing against at least one stop edge of the retaining bracket in a manner which is secured against displacement counter to a plugging in direction. This object is also achieved by a retaining bracket as claimed.

The invention makes a substantially simpler realization of structural preconditions for fixing the securing element possible, since the required installation space is substantially smaller than that required according to the prior art, at least with regard to the necessary height of the installation space.

This is particularly significant given the narrow space conditions that prevail, since the mounting and dismantling of the securing element, which is necessary to exchange the brake linings, is considerably simpler.

Since the securing element, which is plugged into at least one receptacle of the brake caliper in the longitudinal axial direction of the retaining bracket, bears against the retaining bracket in a manner which is secured against displacement, a substantial improvement in the operational reliability of the disk brake is achieved.

When the connection of the securing element to the brake caliper is interrupted, for example as a result of loss of a securing cotter pin or the like, the securing element nevertheless cannot slide out of the brake caliper, not even in the usually rough conditions present during operation of a commercial vehicle due to vibration loading.

This securing feature can also be realized with low expenditure. Additional structural measures are not required; instead, only an appropriate shape of the retaining bracket is needed.

The securing element preferably bears against one or two stop edges of the retaining bracket, which stop edges, in practice, form a stop, and can be brought out of contact with the securing element only by pressing down the retaining bracket counter to the pressure of the lining holding spring.

The stop edges mentioned above can be formed by cutouts in the retaining bracket made during production, for example, by punching.

In order to mount the securing element, which is supported in regions on the upper side of the retaining bracket, in the functional position, it is pressed down counter to the force of the lining holding spring, and the securing element is plugged into a corresponding receptacle of the brake caliper until it has passed the region of the stop edge. When the retaining bracket is released, it is raised by the pressure of the lining holding spring in the direction of the securing element until the securing element, or limbs which are formed on it, lie in the recess of the retaining bracket in a manner which is secured axially counter to the plugging in direction.

Further advantageous features of the invention are reflected in the claims.

In the following, one embodiment of the invention will be described using the appended drawings.

### BRIEF DESCRIPTION OF THE DRAWINGS

FIG. 1 shows a disk brake according to the invention in a plan view, and

FIG. 2 shows a partial detail of the disk brake in a perspective view.

### DETAILED DESCRIPTION OF THE INVENTION

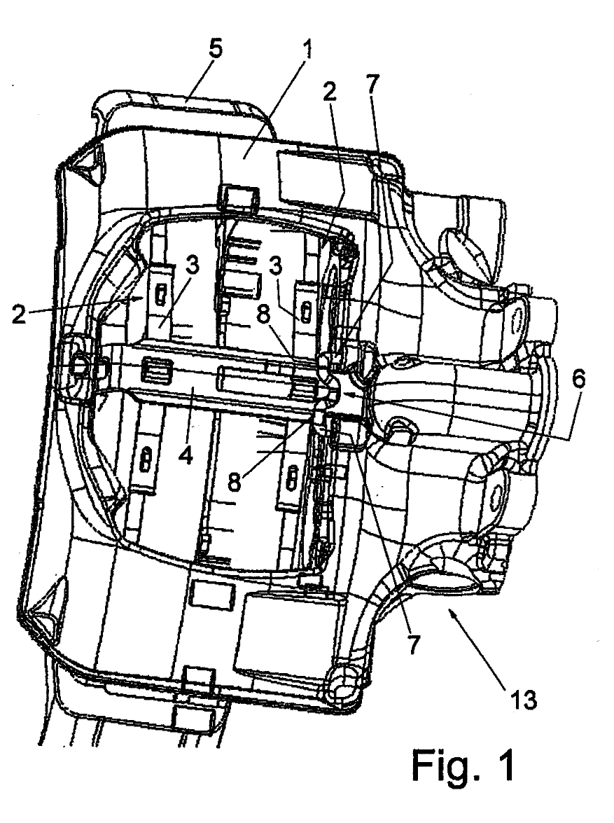

FIG. 1 shows a disk brake for a commercial vehicle having a brake caliper 1, which has a receiving space 13 for a brake application device (not shown), which has a brake disk that can be brought into operative connection with brake linings 2, and which is fastened to a brake carrier 5.

The retaining bracket 4 is fastened releasably to the brake caliper 1. Lining holding springs 3 in the form of leaf springs that act on the outer edges of the brake linings 2 are supported on the retaining bracket 4.

The lining holding springs 3 are fastened, in each case, to a lining carrier plate 11 of the brake lining 2, and the lining carrier plate 11 carries a brake lining 12, which makes contact with the brake disk during a brake operation.

The retaining bracket 4 is held with one end on that side of the brake caliper 1 lying opposite the receiving space 13 and with the other end connected to the brake caliper 1 via a securing element 6.

This securing element 6 has two limbs 7 extending parallel to and at a spacing from one another. The limbs are connected to one another and are plugged into openings of the brake caliper 1 in the longitudinal axial direction of the retaining bracket 4. The connecting region of the two limbs 7 is supported on the upper side of the retaining bracket 4.

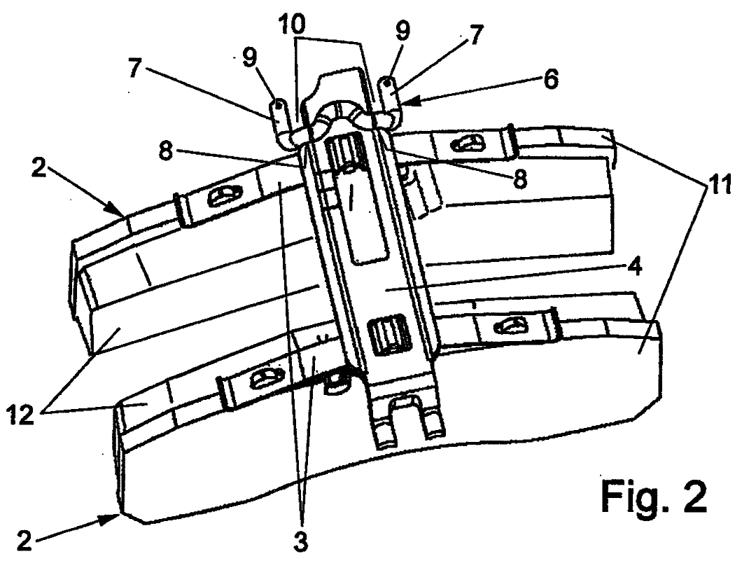

As FIG. 2 shows, the securing element 6, which is otherwise secured against sliding on the brake caliper by cotter pins guided through pinholes 9 of the limbs 7, bears against stop edges 8 of the retaining bracket 4. As a result, the securing element 6 is secured against displacement even in the unsecured position, that is to say if the cotter pins are not plugged in.

The stop edges 8 are formed by the boundary, in each case, of one recess 10, which is provided laterally on the retaining bracket 4. That recess is made, for example, by punching.

A design of the stop edges deviating from the exemplary embodiment shown, which stop edges are expediently made by punching or stamping, is conceivable in principle and, inter alia, is dependent on the shape of the securing element 6.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We claim:

1. A disk brake for a commercial vehicle, comprising:
a brake caliper that has a receiving space for a brake application device and encloses a brake disk, against which brake linings can be pressed during a brake operation, and
a retaining bracket fastened releasably to the brake caliper, on which lining holding springs that act on the outer edges of the brake linings are supported, connected with one end positively to the brake caliper, and held with its other end by way of a securing element,
wherein the securing element is plugged into at least one receptacle of the brake caliper in a longitudinal axial direction of the retaining bracket and bears against at least one stop edge of the retaining bracket in a manner which is secured against displacement counter to a plugging in direction.

2. The disk brake as claimed in claim 1, wherein the securing element has two limbs arranged parallel to and at a spacing from one another and plugged into a receptacle of the brake caliper, and wherein the securing element bears against the at least one stop edge in a connecting region of the two limbs.

3. The disk brake as claimed in claim 1, wherein each stop edge is formed by a boundary of a recess.

4. The disk brake as claimed in claim 3, wherein the recess is one of multiple recesses provided on both longitudinal sides of the retaining bracket.

5. The disk brake as claimed in claim 4, wherein the recesses are made by punching.

6. The disk brake as claimed in claim 1, wherein the at least one stop edge is made by stamping.

7. A retaining bracket for fixing brake linings of a disk brake in accordance with claim 1, wherein the retaining bracket has at least one stop edge against which the securing element that is plugged into the at least one receptacle bears in a manner that is secured against displacement in the longitudinal axial direction of the retaining bracket.

8. The disk brake as claimed in claim 2, wherein each stop edge is formed by a boundary of a recess.

9. The disk brake as claimed in claim 8, wherein the recess is one of multiple recesses provided on both longitudinal sides of the retaining bracket.

10. The disk brake as claimed in claim 9, wherein the recesses are made by punching.

11. The disk brake as claimed in claim 2, wherein the at least one stop edge is made by stamping.

12. The disk brake as claimed in claim 3, wherein the at least one stop edge is made by stamping.

13. The disk brake as claimed in claim 4, wherein the at least one stop edge is made by stamping.

14. The disk brake as claimed in claim 5, wherein the at least one stop edge is made by stamping.

15. A retaining bracket for fixing brake linings of a disk brake in accordance with claim 2, wherein the retaining bracket has at least one stop edge against which the securing element that is plugged into the at least one receptacle bears in a manner that is secured against displacement in the longitudinal axial direction of the retaining bracket.

16. A retaining bracket for fixing brake linings of a disk brake in accordance with claim 3, wherein the retaining bracket has at least one stop edge against which the securing element that is plugged into the at least one receptacle bears in a manner that is secured against displacement in the longitudinal axial direction of the retaining bracket.

17. A retaining bracket for fixing brake linings of a disk brake in accordance with claim 4, wherein the retaining bracket has at least one stop edge against which the securing element that is plugged into the at least one receptacle bears in a manner that is secured against displacement in the longitudinal axial direction of the retaining bracket.

18. A retaining bracket for fixing brake linings of a disk brake in accordance with claim 5, wherein the retaining bracket has at least one stop edge against which the securing element that is plugged into the at least one receptacle bears in a manner that is secured against displacement in the longitudinal axial direction of the retaining bracket.

19. A retaining bracket for fixing brake linings of a disk brake in accordance with claim 6, wherein the retaining bracket has at least one stop edge against which the securing element that is plugged into the at least one receptacle bears in a manner that is secured against displacement in the longitudinal axial direction of the retaining bracket.

20. A retaining bracket for fixing brake linings of a disk brake in accordance with claim 8, wherein the retaining bracket has at least one stop edge against which the securing element that is plugged into the at least one receptacle bears in a manner that is secured against displacement in the longitudinal axial direction of the retaining bracket.
